(19) United States
(12) Patent Application Publication
(10) Pub. No.: US 2013/0036918 A1
(43) Pub. Date: Feb. 14, 2013

(54) HEAT COOKING DEVICE

(71) Applicant: Yasuaki Sakane, Osaka-Shi (JP)

(72) Inventor: Yasuaki Sakane, Osaka-Shi (JP)

(73) Assignee: SHARP KABUSHIKI KAISHA, Osaka-Shi, Osaka (JP)

(21) Appl. No.: 13/641,706

(22) PCT Filed: May 10, 2011
(86) PCT No.: PCT/JP2011/060723

§ 371 Date: Oct. 17, 2012

(30) Foreign Application Priority Data
May 11, 2010 (JP) 2010-108964

(51) Int. Cl. A47J 27/00

(52) U.S. Cl. 99/358

(57) ABSTRACT

Tableware (F) put inside a heating chamber (20) of the disclosed heat cooking device (1) is heated by means of high-frequency waves, steam, hot air, or a combination thereof. The heating chamber is provided with a circulating fan (51) and an air supply/emission fan (31). An air supply tube (36) to the heating chamber and an air emission tube (37) from the heating chamber are provided to a blowing duct (33) that links the air supply/emission fan and an emission port (32). An ion generator (44) is disposed at the air supply tube. A duct switching device (40) that selects whether to introduce positive/negative ions generated by the ion generator into the heating chamber or to release the ions to the outside of the heat cooking device is provided to the air supply tube and the air emission tube.

### TECHNICAL FIELD

The present invention relates to a cooking device.

### BACKGROUND ART

What bothers a user of an oven-type cooking device is, for example, odors remaining in a heating chamber. Odors may come from food to be cooked, or, dirt adhering on surfaces inside the heating chamber may be the source of odors. Such dirt can be hotbeds of various germs.

There have been proposed cooking devices equipped with means to deal with such odors and dirt. For example, a cooking device disclosed in Patent Literature 1 blows radicalized steam into a heating chamber to act on odors from an object to be cooked, and dirt and germs in the heating chamber, to thereby maintain the quality of the object to be cooked.

### CITATION LIST

### Patent Literature

Patent Literature 1 JP-A-2006-3029

### SUMMARY OF INVENTION

### Technical Problem

A cooking device disclosed in Patent Literature 1 uses radicalized steam to deodorize and sterilize the heating chamber. A portion hit by the steam is heated and humidified. The heating and humidification in this way is not always desirable for all objects to be deodorized or sterilized. It even might be better for some objects to refrain from being heated or humidified.

The present invention has been made in view of the foregoing, and an object of the present invention is to provide a cooking device capable of deodorizing and sterilizing a heating chamber or an article placed therein without heating and humidification.

### Solution to Problem

According to a preferable embodiment of the present invention, a cooking device includes a heating chamber, air inflow path through which air is made to flow into the heating chamber, and an ion generator which emits positive and negative ions into air that flows through the air inflow path.

According to another preferable embodiment of the present invention, the cooking device having the above configuration further includes a flow path switching device which outwardly discharges air that flows through the air inflow path and includes positive and negative ions.

According to still another preferable embodiment of the present invention, in the cooking device having the above configuration, an airflow in the air inflow path is generated by a fan, and the fan and the ion generator are able to be driven regardless of whether cooking is performed or not.

According to still another preferable embodiment of the present invention, in the cooking device having the above configuration, a circulation duct which circulates air in the heating chamber is provided outside the heating chamber, the circulation duct functioning as part of the air inflow path.

According to still another preferable embodiment of the present invention, in the cooking device having the above configuration, the ion generator is disposed outside the circulation duct.

According to still another preferable embodiment of the present invention, in the cooking device having the above configuration, the ion generator is disposed inside the circulation duct.

According to still another preferable embodiment of the present invention, the cooking device having the above configuration further includes a heater which heats gas that flows into the heating chamber.

According to still another preferable embodiment of the present invention, the cooking device having the above configuration further includes a steam generator which supplies steam into the heating chamber.

According to still another preferable embodiment of the present invention, the cooking device having the above configuration further includes a microwave generator which supplies a microwave into the heating chamber.

### Advantageous Effects of Invention

According to the present invention, positive and negative ions are supplied to air that flows into a heating chamber such that deodorization and sterilization are achieved by actions of positive and negative ions. Thus, it is possible to deodorize and sterilize the heating chamber or an article placed therein while not necessarily applying heat or humidity.

### BRIEF DESCRIPTION OF DRAWINGS

FIG. 1 is a front view showing a first embodiment of a cooking device according to the present invention;

FIG. 2 is a vertical sectional view schematically showing the cooking device as viewed from a front side;

FIG. 3 is a vertical sectional view schematically showing the cooking device as viewed from the front side, in a different state from FIG. 2;

FIG. 4 is a front view of an operation portion of the cooking device;

FIG. 5 is a block diagram showing a configuration of the cooking device;

FIG. 6 is a first flow chart for illustrating an operation of the cooking device;

FIG. 7 is a second flow chart for illustrating an operation of the cooking device; and

FIG. 8 is a vertical sectional view schematically showing a second embodiment of a cooking device according to the present invention illustrated in the same manner as FIG. 3.

### DESCRIPTION OF EMBODIMENTS

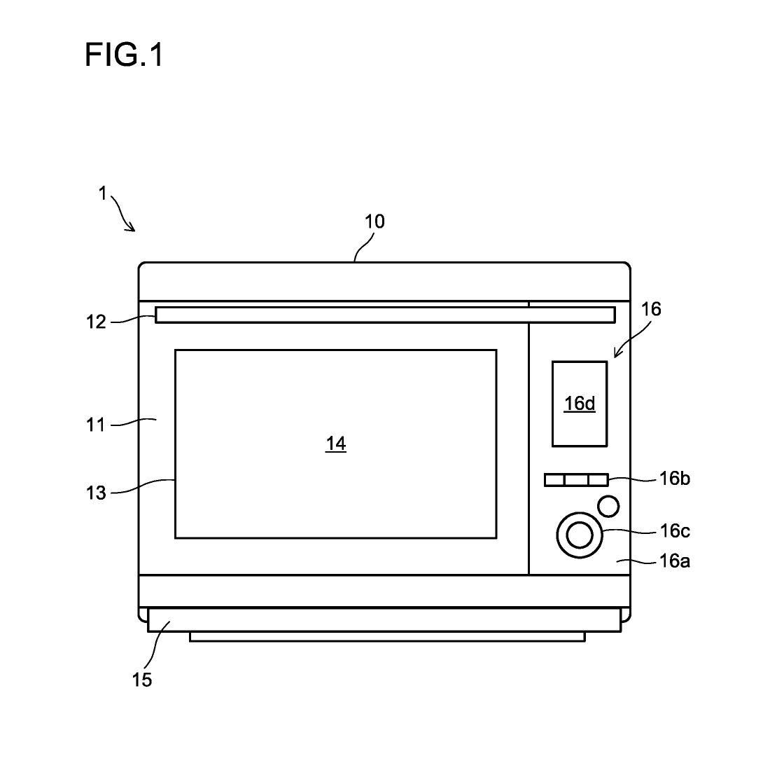

Hereinafter, with reference to the accompanying drawings, a description will be given of a configuration of a cooking device 1. In FIG. 1, the top and the bottom of the sheet coincide with the top and the bottom of the cooking device 1. As for the right side and the left side of the cooking device 1, it is defined that the left side and the right side of the sheet coincide with the left side and the right side of the cooking device 1, respectively.

The cooking device 1 is provided with a housing 10 which is a rectangular parallelepiped structure made of sheet metal. Inside the housing 10, there is provided a heating chamber 20 which is a rectangular parallelepiped structure made of sheet metal and one size smaller than the housing 10. The heating chamber 20 has an opening portion formed at a portion thereof corresponding to the front side of the housing 10. A door 11 made of metal is provided at the front side of the housing 10 to open and close the opening portion of the heating chamber 20. The door 11 is rotatable in a perpendicular plane around a bottom end thereof, such that the door 11 can be moved by 90° from a perpendicular fully-closed position to a horizontal fully-open position by holding a handle 12 provided at an upper portion thereof to pull the door 11 frontward.

In the door 11, a window 13 is formed for seeing inside of the heating chamber 20 therethrough. The window 13 has fitted therein a door screen 14 formed of two glass sheets and a perforated metal sheet held between the two glass sheets, such that it is possible to prevent leakage of the microwave through the window 13 while achieving the visibility of the inside of the heating chamber 20 through the window 13. Besides the door screen 14, the door 11 is provided with other measures for preventing leakage of the microwave. A gasket is disposed between the door 11 and the heating chamber 20 for preventing leakage of gas. The door 11 is provided with a biasing device or a locking device which functions to keep the door 11 in a closed state. These configurations are all well-known technologies, and thus, detailed descriptions thereof will be omitted.

Steam from a food material that is being cooked or steam used for cooking is sometimes condenses on an inner surface of the door 11. In order to prevent condensed water from dripping down to wet where the cooking device 1 is located, a drip pan 15 is disposed under the door 11.

In the housing 10, there is formed an operation portion 16 to the right of the door 11. An operation portion cover 16a which is part of the housing 10 includes operational interfaces such as a group of operation keys 16b and an encoder dial 16c. A display portion 16d is disposed above the operation keys 16b.

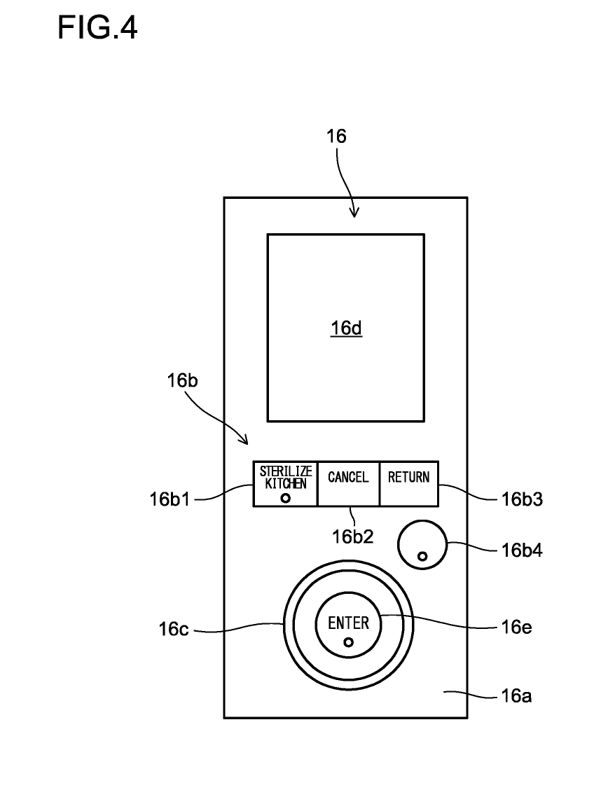

The operation portion 16 is illustrated in detail in FIG. 4. The operation keys 16b include the following four kinds of keys. That is, a kitchen sterilization key 16b1, a cancel key 16b2, a return key 16b3, and a start key 16b4. An enter key 16e is provided at a center of the encoder dial 16c. Small circles illustrated inside the kitchen sterilization key 16b1, the start key 16b4, and the enter key 16e indicate LED lamps each provided to indicate that an operation started by pressing on the button is going on.

The housing 10 is supported on a table top or on some platform via leg portions 17. The leg portions 17 are disposed one at each of right and left sides of both of front and rear sides, whereby four point support is achieved.

An internal configuration of the cooking device 1 will be described. Two kinds of fans are disposed outside of a side wall on a right side (hereinafter, a “right side wall”) of the heating chamber 20. One is an air supply/discharge fan 31, and the other is a circulation fan 51. The air supply/discharge fan 31 takes in air from outside the housing 10, and discharges the air through an outlet port 32 which is formed above a top face of the housing 10. The air is discharged after passing through the heating chamber 20 or without passing through the heating chamber 20. The circulation fan 51 circulates gas existing inside the heating chamber 20.

A description will be given of an air supply/discharge passage 30 which includes the air supply/discharge fan 31 and the outlet port 32 as components. A main part of the air supply/discharge passage 30 is a ventilation duct 33. The ventilation duct 33 extends vertically so as to couple a fan casing 34, in which the air supply/discharge fan 31 is housed, to the outlet port 32. The ventilation duct 33 has an ejector portion 35 which is disposed a little below the outlet port 32.

An air supply pipe 36 horizontally extends from a portion of the ventilation duct 33a little below the ejector portion 35, and the air supply pipe 36 functions as an air inflow path through which air flows into the heating chamber 20. An air discharge pipe 37 horizontally extends from the ejector portion 35, and the air discharge pipe 37 functions as an air outflow path through which air flows out from the heating chamber 20. The air supply pipe 36 is connected to an outlet port 21 which is formed in the right side wall of the heating chamber 20. The air discharge pipe 37 is connected to an inlet port 22 which is also formed in the right side wall of the heating chamber 20. The outlet port 21 and the inlet port 22 are both formed of a plurality of small holes.

An air supply damper 38 is provided at some midpoint in the air supply pipe 36. An air discharge damper 39 is provided at some midpoint in the air discharge pipe 37. The air supply damper 38 and the air discharge damper 39 are both electrically driven, and together form a flow path switching device 40. A return pipe 41 is connected to the air supply damper 38, and the return pipe 41 is also connected to the ejector portion 35. An inlet pipe 42 is connected to the air discharge damper 39, and the inlet pipe 42 sucks in air from outside the housing 10.

The air supply damper 38 is switchable between first and second states. In the first state, the air supply damper 38 opens a flow path from the ventilation duct 33 to the outlet port 21 and shuts a flow path to the return pipe 41. In the second state, the air supply damper 38 closes the flow path from the ventilation duct 33 to the outlet port 21 and opens the flow path to the return pipe 41. The first state is defined as an “open” state of the air supply damper 38, and the second state is defined as a “closed” state of the air supply damper 38.

The air discharge damper 39 is switchable between first and second states. In the first state, the air discharge damper 39 opens a flow path from the inlet port 22 to the ventilation duct 33 and shuts a flow path from the inlet pipe 42. In the second state, the air discharge damper 39 shuts the flow path from the inlet port 22 to the ventilation duct 33 and opens the flow path from the inlet pipe 42. The first state is defined as an “open” state of the air discharge damper 39, and the second state is defined as a “closed” state of the air discharge damper 39.

To the ejector portion 35, there is also connected an air discharge pipe 43 which extends from an outlet port 23 which is provided near the bottom portion of the heating chamber 20.

An ion generator 44 is provided in the air supply pipe 36, at a position between the ventilation duct 33 and the air supply damper 38. The ion generator 44 emits positive and negative ions into air flowing through the air supply pipe 36.

An absolute humidity sensor 45 is provided in the air discharge pipe 37, at a position between the air discharge damper 39 and the ejector portion 35. The absolute humidity sensor 45 measures humidity of air flowing through the air discharge pipe 37.

A description will be given of a circulation passage 50 which includes the circulation fan 51 as a component. A main part of the circulation passage 50 is a circulation duct 52 which is provided outside the heating chamber 20. The circulation duct 52 has a start point at an inlet port 24 formed in the right side wall of the heating chamber and has an end point at outlet ports 25U, 25D provided in a left side wall of the heating chamber 20. Part of the circulation duct 52 between the start and end points thereof is located above the top face of the heating chamber 20. The inlet port 24 and the outlet ports 25U, 25D are all formed of a plurality of small holes.

Inside the circulation duct 52, at a position facing the inlet port 24, there is formed a fan casing 53 in which the circulation fan 51 is accommodated. A temperature sensor 54 is disposed between the inlet port 24 and the fan casing 53.

The cooking device 1 is capable of performing microwave cooking, hot air cooking, steam cooking, and combination of these. Descriptions will be given of configurations of the various heating means.

In a space between a bottom portion of the heating chamber 20 and a bottom portion of the housing 10, there are disposed a magnetron 60 and a waveguide 61 through which microwave from the magnetron 60 is supplied to the heating chamber 20. The waveguide 61 is connected to an antenna chamber 62 which is formed under the bottom portion of the heating chamber 20. A bottom tray 63 is fitted to the bottom portion of the heating chamber 20, the bottom tray being formed of a dielectric substance such as glass or ceramic. The bottom tray 63 separates the antenna chamber 62 from the heating chamber 20. The bottom tray 63 serves both as a bottom panel of the heating chamber 20 and a top panel of the antenna chamber 62.

A rotary antenna 64 is disposed in the antenna chamber 62. The rotary antenna 64 is attached to a top end of a shaft 65a of an antenna motor 65. The rotary antenna 64 is caused to continuously rotate in a horizontal plane by rotation of the antenna motor 65, meanwhile controlling the distribution of a microwave in the heating chamber 20.

Hot air cooking is achieved by a gas heating heater 56 which is disposed inside the circulation duct 52. A portion of the circulation duct 52 above the top face of the heating chamber 20 is formed as a gas heating heater chamber 57, in which the gas heating heater 56 is disposed. A large number of outlet ports 58 are formed in a dispersed manner in the plate member which functions both as a bottom portion of the gas heating heater chamber 57 and a ceiling portion of the heating chamber 20.

Steam cooking is achieved by a steam generator 70 which is disposed outside the right side wall of the heating chamber 20. The steam generator 70 boils water put therein by using a steam generating heater 71 to thereby generate saturated steam. A steam supply pipe 72 which extends from the steam generator 70 is connected to the circulation duct 52. The connection is made at an upstream side of the fan casing 53.

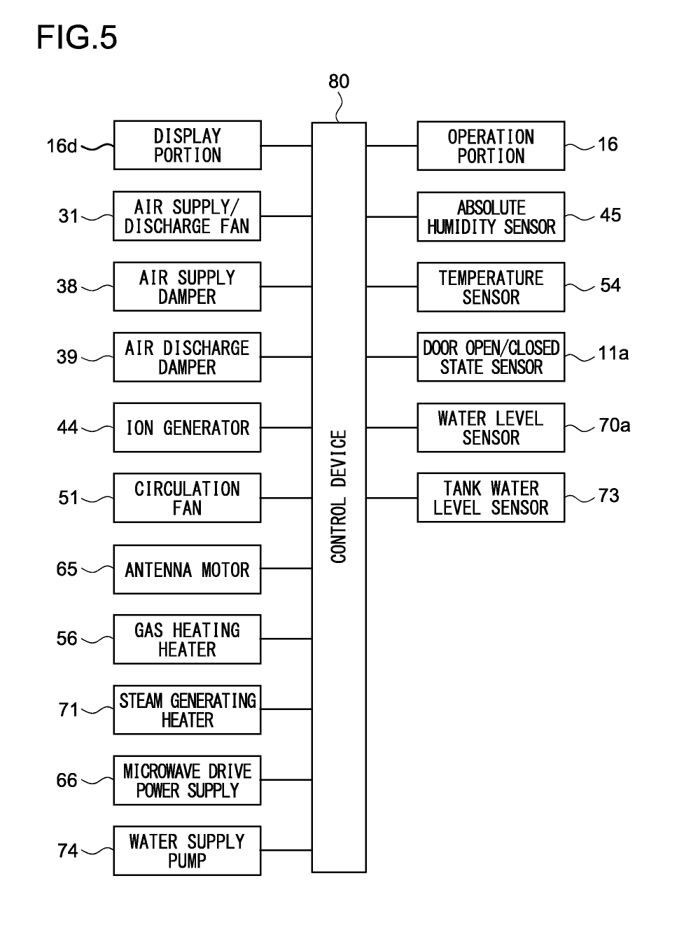

A control system for the cooking device 1 is configured as shown in FIG. 5. A control device 80 which controls the entire cooking device 1 is built with a microcomputer as a core. The control device 80 receives output signals from various components, and transmits control signals to various components.

The components which transmits output signals to the control device 80 include the operation portion 16 (excluding the display portion 16d), the absolute humidity sensor 45, and the temperature sensor 54, and in addition to these which have already been mentioned above, the following are also included. That is, a door open/closed state sensor 11a which detects whether the door 11 is in an open state or in a closed state, a water level sensor 70a which measures a water level in the steam generator 70, and a tank water level sensor 73 which measures a water level in an unillustrated water tank.

The components which operate by receiving control signals from the control device 80 include the display portion 16d, the air supply/discharge fan 31, the air supply damper 38, the air discharge damper 39, the ion generator 44, the circulation fan 51, the antenna motor 65, and the gas heating heater 56, and in addition to these which have already been mentioned above, the following are also included. That is, a microwave drive power supply 66 which energizes the magnetron 60, and a water supply pump 74 which supplies water from the unillustrated water tank to the steam generator 70.

Operations of the cooking device 1 will now be described. First, the door 11 is opened, and food F as a target to be cooked is place in the heating chamber 20. Then, the door 11 is closed, cooking conditions are input via the operation portion 16, and the start key 16b4 is pressed on, when cooking starts to be performed.

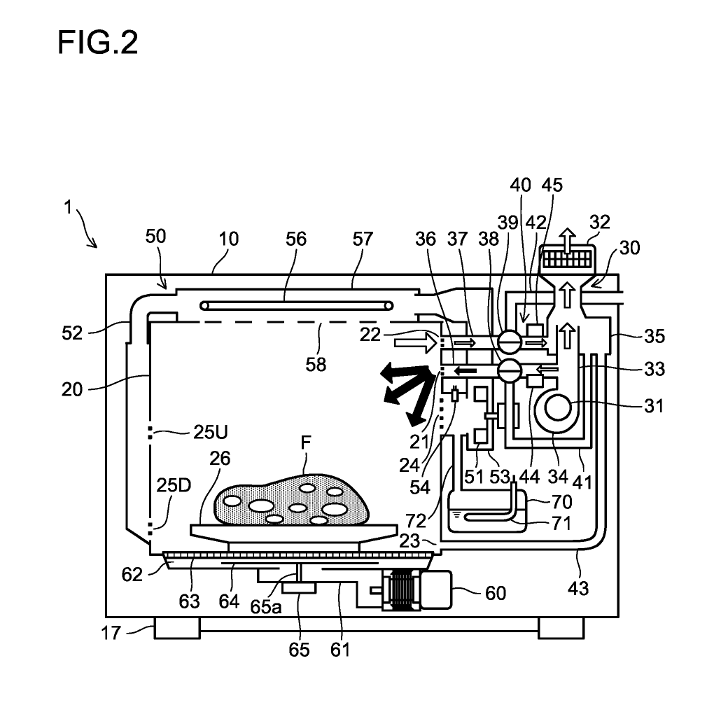

FIG. 2 shows a situation where microwave cooking is performed. The food F is placed on a plate 26 on the bottom tray 63. Here, the microwave drive power supply 66, the air supply/discharge fan 31, and the antenna motor 65 are turned on. The air supply damper 38 and the air discharge damper 39 are both in the open states.

When the microwave drive power supply 66 is turned on, the magnetron 60 starts oscillating, and thereby a microwave is generated. The thus generated microwave enters the antenna chamber 62 through the waveguide 61. On entering the antenna chamber 62, the microwave is received by the antenna 64, and then, the microwave is emitted into the heating chamber 20 through the bottom tray 63, to heat the food F in the heating chamber 20.

When the air supply/discharge fan 31 is turned on, air is sucked into the fan casing 34 from outside the housing 10. The air is then sent from the fan casing 34 toward the outlet port 32, but part of the air enters the air supply pipe 36, to be blown into the heating chamber 20 through the outlet port 21. Thus, the air supply pipe 36 serves as an air inflow path through which air is made to flow into the heating chamber 20.

An airflow toward the outlet port 32 causes negative pressure in the ejector portion 35, and thanks to the negative pressure, air inside the heating chamber 20 is sucked out from the heating chamber 20. The air is sucked out from the heating chamber 20 via two routes, that is, a route from the inlet port 22 through the air discharge pipe 37, and a route from the outlet port 23 through the air discharge pipe 43. The sucked-out air joins a main stream of the airflow flowing through the ventilation duct 33, to be discharged to the outside of the casing 10 through the outlet port 32.

Thus, fresh air outside the casing 10 is supplied to the heating chamber 20. Air inside the heating chamber 20 that contains steam and odors from the food F is sucked out from the heating chamber 20 into the ejector portion 35, and the air is then diluted with outside air that flows upward through the ventilation duct 33, to be discharged to the outside of the casing 10.

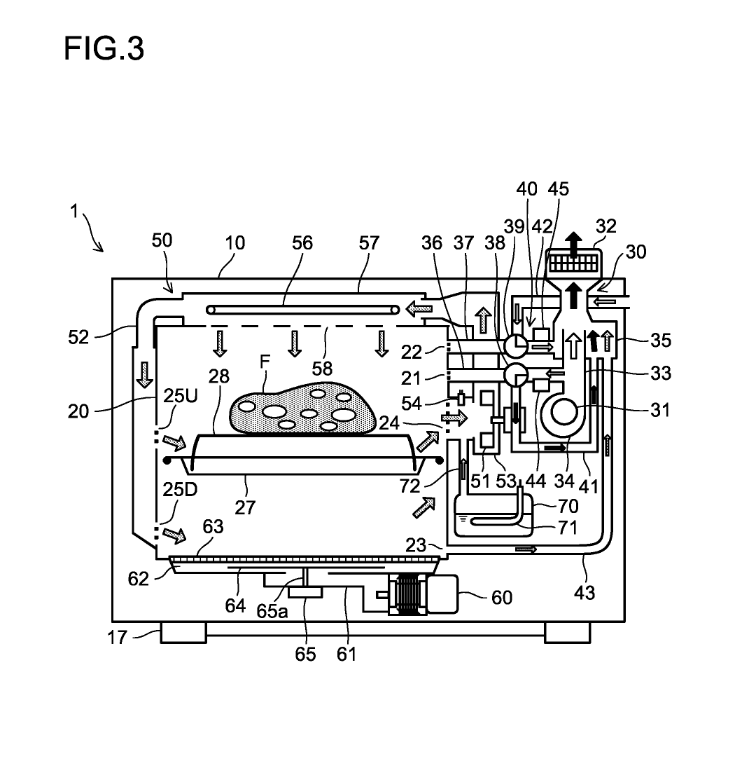

FIG. 3 shows a situation where superheated-steam cooking is performed. The food F is supported on a rack 28 made of a metal wire material above a metal tray 27. The tray 27 has two opposing side edges thereof supported by unillustrated tray holders which are respectively formed on the right and left side walls of the heating chamber 20. The tray holders are formed at a height between the outlet port 25U and the outlet port 25D.

In this situation, the steam generating heater 71, the gas heating heater 56, and the circulation fan 51 are on. The air supply damper 38 and the air discharge damper 39 are each in the closed state.

When the circulation fan 51 is turned on, a circulating airflow is formed such that air is sucked out from the heating chamber 20 through the inlet port 24 to flow through the circulation duct 52 to return to the heating chamber 20 via the outlet ports 25U, 25D. That is, the circulation passage 50 is part of the air inflow path through which air is made to flow into the heating chamber 20. Saturated steam generated by boiling water in the steam generator 70 is sent to the circulation duct 52 through the steam supply pipe 72 to join the circulating airflow, and flows toward the gas heating heater 56.

The saturated steam hits the gas heating heater 56 in a heat generating state to be heated to become superheated steam. Part of the superheated steam is blown downward from the outlet ports 58 into the heating chamber 20 to surround the food F. The rest of the superheated steam is blown from the outlet ports 25U, 25D into the heating chamber 20 to surround the food F. The food F surrounded by the superheated steam is cooked by receiving heat both as heat of the superheated steam itself and as latent heat that becomes sensible when the superheated steam comes in contact with a surface of the food F to condense into liquid water. Steam in the heating chamber 20 repeatedly circulates such that it is sucked out from the heating chamber 20 through the inlet port 24 and returns to the heating chamber 20 through the outlet ports 58, 25U, and 25D.

Excess air or steam in the heating chamber 20 flows through the air discharge pipe 43 to be discharged from the outlet port 32. As the air inside the heating chamber 20 is replaced with steam, the inside of the heating chamber 20 becomes hypoxic. This makes it possible to cook the food F without ruining its taste. The superheated steam that comes in contact with the surface of the food F condenses into liquid water and drips down into the tray 27, meanwhile dissolving oil/fat and salt contained in the food F, and thus it is possible to achieve low-fat, low-salt cooking.

Steam cooking with saturated steam can be performed by turning on only the steam generating heater 71 and the circulation fan 51 and turning off the gas heating heater 56. Hot air cooking can be performed by turning on only the steam heating heater 56 and the circulation fan 51 and turning off the steam generating heater 71.

Superheated-steam cooking, steam cooking with saturated steam, and hot air cooking can each be performed in combination with microwave cooking.

In the cases of cooking performed by using superheated steam or saturated steam, if the air supply/discharge fan 31 is turned on, steam that enters the ejector portion 35 from the air discharge pipe 43 is diluted with air flowing in the ventilation duct 33 to be cooled down and thus safe. Furthermore, relative humidity is lowered by the dilution with the air, and this helps reduce dew condensation on surrounding walls.

After a sequence of microwave cooking, superheated-steam cooking, steam cooking with saturated steam, hot air cooking, or cooking in combination of these, the door 11 is opened. Then, the food F is taken out from the heating chamber 20.

When the air supply damper 38 and the air discharge damper 39 are open and the air supply/discharge fan 31 is on, that is, in microwave cooking, if the ion generator 44 is turned on, positive and negative ions are introduced into the heating chamber 20. In FIG. 2, black solid arrows each indicate an airflow containing positive and negative ions.

When a voltage of an AC waveform or an impulse waveform is applied to an unillustrated electrode in the ion generator 44, if the applied voltage is a positive voltage, positive ions mainly including H⁺(H₂O)ₙ are generated, while, if the applied voltage is a negative voltage, negative ions mainly including O₂⁻(H₂O)ₘ are generated. Here, n, m are integer numbers. H⁺(H₂O)ₙ and O₂⁻(H₂O)ₘ ions surround microorganisms existing in the heating chamber 20, and collect on surfaces of the microorganisms.

When H⁺(H₂O)ₙ meets O₂⁻(H₂O)ₘ, they go through chemical reactions represented by the following formulae (1) to (3), to generate [.OH] (hydroxyl radical) and H₂O₂ (hydrogen peroxide), which are active species.

H⁺(H₂O)ₙ+O₂⁻(H₂O)ₘ→.OH+½O₂+(n+m)H₂O (1)

H⁺(H₂O)ₙ+H⁺(H₂O)_{n′}+O₂⁻(H₂O)ₘ+O₂⁻(H₂O)_{m′}→2.OH+O₂+(n+n′+m+m′)H₂O (2)

H⁺(H₂O)ₙ+H⁺(H₂O)_{n′}+O₂⁻(H₂O)ₘ+O₂⁻(H₂O)_{m′}→H₂O₂+(n+n′+m+m′)H₂O (3)

[.OH] and H₂O₂ have extremely high activity, and thus it is possible to perform sterilization by using their activity.

[.OH] acts on a C—C bond, a C═C bond, a C═O bond, and the like of odor-causing organic compounds to decompose such bonds. This generates a deodorization effect. The following formulae (4) to (6) each represent decomposition of a typical odor-causing substance.

Reaction with acetic acid:

CH₃COOH+8.OH→2CO₂+6H₂O (4)

Reaction with acetaldehyde:

CH₃CHO+10.OH→2CO₂+7H₂O (5)

Reaction with benzene:

C₆H₆+30.OH→6CO₂+18H₂O (6)

Thus, by introducing highly concentrated positive and negative ions exclusively into the heating chamber 20 by the flow path switching device 40 which is composed of the air supply damper 38 and the air discharge damper 39, it is possible to remove microorganisms floating in an interior space of the heating chamber 20 or adhering on surfaces of the heating chamber 20 and the food F. Furthermore, it is possible to perform deodorization by decomposing odor-causing substances floating in the interior space of the heating chamber 20 or adhering on the surfaces of the heating chamber 20 and the food F. Incidentally, the concentrations of the positive and negative ions measured at a center portion of the interior space of the heating chamber 20 in this case were each approximately 400,000 ions/cc, which is sufficiently high for sterilization and deodorization.

Table 1 below shows results of experiments conducted to confirm the deodorization effect. In the experiments, a clove of garlic was heated in a heating chamber for two minutes by using a microwave at power of 600 W. The heating was followed by continuous 10-minute ventilation of air into the heating chamber, with or without supply of positive and negative ions into the air. Subsequently, sensory tests were conducted to evaluate odors remaining in the heating chamber after the 10-minute ventilation, with respect to cases both with and without the supply of positive and negative ions. According to the results of the sensory tests, no odor remained in the cases where the positive and negative ions were supplied, but some odors remained in the cases where the positive and negative ions were not supplied.

TABLE 1
Residual odor in the heating chamber
Positive and negative ions were continuously supplied to the heating
chamber for 10 minutes, then after 5 minutes of rest thereafter, sensory
tests were conducted to compare the cases with respect to remaining odors.

| | Heating a garlic clove in | With vinegar |
|---|---|---|
| | a range at | thinly applied inside a |
| | 600 W for 2 minutes | heating chamber |
| Ion generator: ON | Hardly any odors remained. | Hardly any odors |
| | | remained. |
| Ion generator: OFF | Odors slightly remained. | Odors remained. |

Part of positive and negative ions introduced into the heating chamber 20 is sucked out from the heating chamber 20 into the ejector portion 35, to join the main stream of the airflow flowing through the ventilation duct 33 to be discharged to the outside of the housing 10 through the outlet port 32. By the rest of the positive and negative ions, odors adhered to the air discharge passage are also removed. However, some of positive and negative ions in the air discharged from the heating chamber 20 to an outside space via the air discharge passage were lost on their way, and thus the concentrations of positive and negative ions were both reduced to approximately 8,000 ions/cc when measured immediately after the air was discharged from the outlet port 32. The concentrations of positive and negative ions are high enough to sterilize the discharged gas itself, but not high enough to sterilize an entire kitchen.

Radicals generated when positive ions meet negative ions are safer and live longer than such radicals as ozone, superoxide anion, hypochlorous acid, and the like. Thus, it is possible to supply radicals to every corner inside the heating chamber 20.

When cooking is performed, moisture evaporating from the food F causes the humidity inside and outside the heating chamber 20 to rise. Moisture, which causes humidity, functions to carry radicals, making it easier for the radicals to be delivered to every corner.

Introduction of positive and negative ions into the heating chamber 20 may be automatically performed along with heating by the microwave, or may be performed by being selected through a key operation on the operation portion 16. For example, the kitchen sterilization key 16b1 can be assigned to it.

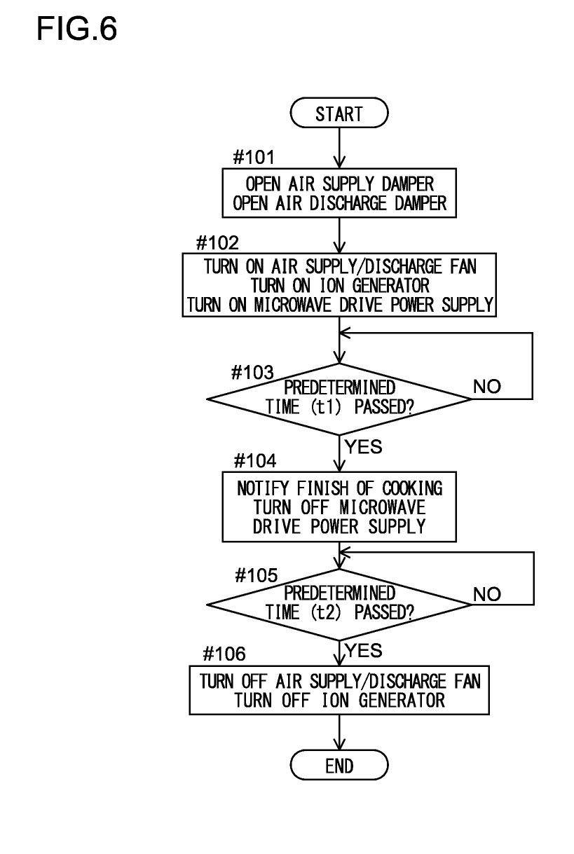

FIG. 6 shows an operation flow of introducing positive and negative ions into the heating chamber 20 while performing microwave cooking. Now, a description will be given of the operation flow.

In step #101, the air supply damper 38 and the air discharge damper 39 are each in an open state.

In step #102, the air supply/discharge fan 31, the ion generator 44, and the microwave drive power supply 66 are turned on, such that the food F starts to be heated and positive and negative ions start to be introduced into the heating chamber 20.

In step #103, it is checked whether a predetermined time (t1) set as a microwave heating time has passed or not. When the predetermined period time is found to have passed, the flow proceeds to step #104.

In step #104, it is notified that the cooking is finished. Also, the microwave drive power supply 66 is turned off. The air supply/discharge fan 31 and the ion generator 44 remain on. Thus, the following operations continue to be performed, that is, discharging air in the heating chamber 20 containing steam and odors from the food F, eliminating microorganisms floating in the interior space of the heating chamber 20 or adhering on the surfaces of the heating chamber 20 and of the food F, and decomposing odor-causing substances floating in the interior space of the heating chamber 20 or adhering on the surfaces of the heating chamber 20 and of the food F.

In step #105, it is checked whether a predetermined time (t2) set as an on-state lasting time for the air supply/discharge fan 31 and the ion generator 44 has passed or not. When the predetermined (t2) is found to have passed, the flow proceeds to step #106.

In step #106, the air supply/discharge fan 31 and the ion generator 44 are turned off. Thereby, the microwave cooking is completely finished.

The ion generator 44 and the air supply/discharge fan 31 can be turned on while cooking is performed with the air supply damper 38 and the air discharge damper 39 each in the closed state, that is, while superheated-steam cooking, steam cooking with saturated steam, or hot air cooking is performed. As shown in FIG. 3, in this mode, positive and negative ions are introduced not into the heating chamber 20 but into the ejector portion 35, to join the main stream of the airflow flowing through the ventilation duct 33 to be discharged through the outlet port 32. That is, positive and negative ions are discharged into a space outside the cooking device 1 to sterilize and deodorize the space. In FIG. 3, black solid arrows indicate an airflow containing positive and negative ions, while shaded arrows indicate a circulating airflow.

In the mode shown in FIG. 3, positive and negative ions are supplied only to the space outside the cooking device 1 by the flow path switching device 40 composed of the air supply damper 38 and the air discharge damper 39. Thus, it is possible to discharge highly concentrated positive and negative ions into the space outside the cooking device 1. Incidentally, the concentrations of positive and negative ions contained in air measured immediately after the air was discharged from the outlet port 32 were each approximately 200,000 ions/cc. These concentrations of positive and negative ions are higher than those obtained in the mode shown in FIG. 2, and high enough not only to sterilize and deodorize the discharged air itself, but also to sterilize and deodorize the entire kitchen.

Radicals generated when positive ions meet negative ions are safer and live longer than such radicals as ozone, superoxide anion, hypochlorous acid, and the like. Thus, if the cooking device 1 is located in a kitchen, radical can be supplied to every corner of the kitchen.

The provision of the flow path switching device 40 makes it possible to supply positive and negative ions exclusively into the heating chamber 20, or, exclusively to the space outside the cooking device 1. As a result, it is possible to make the concentrations of positive and negative ions higher than those in a case without the flow path switching device 40 where positive and negative ions are dividedly supplied simultaneously into the heating chamber 20 and to the space outside the cooking device 1. Therefore, it is possible to achieve enhanced sterilization and deodorization both in the heating chamber 20 and in the space outside the cooking device 1.

The discharge of positive and negative ions to the space outside the cooking device 1 is preferably performed automatically along with the superheated-steam cooking, the steam cooking with saturated steam, and the hot air cooking. Or, the discharge may be selected by operating a key in the operation portion 16. In the case where the discharge can be selected by a key operation on the operation portion 16, the kitchen sterilization key 16b1 can be assigned to it, for example.

In this embodiment, even when cooking is not performed, the ion generator 44 and the air supply/discharge fan 31 can be turned on by pressing on the kitchen sterilization key 16b1. That is, regardless of the cooking state, it is possible to discharge positive and negative ions to the space outside the cooking device 1 at any desired timing to thereby sterilize and deodorize the space.

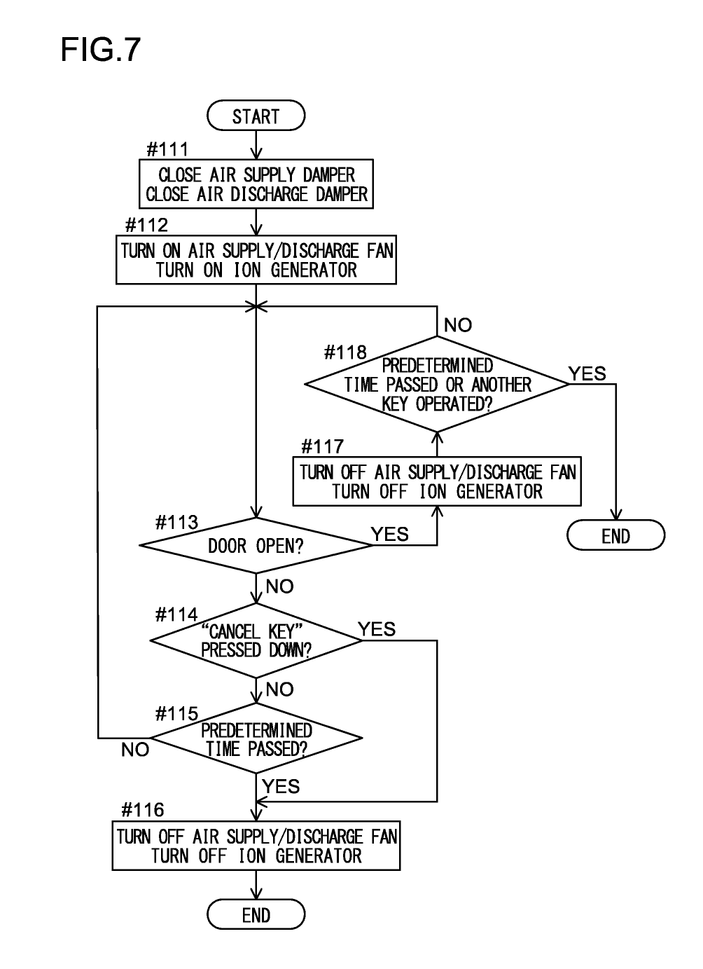

FIG. 7 shows an operation flow of sterilization and deodorization of the space outside the cooking device 1 when cooking is not performed. Now, a description will be given of the operation flow.

In step #111, the air supply damper 38 and the air discharge damper 39 are each in the closed state.

In step #112, the air supply/discharge fan 31 and the ion generator 44 are turned on. Thereby, positive and negative ions start to be discharged to the space outside the cooking device 1.

In step #113, it is checked whether the door 11 has been opened or not. If the door 11 has been opened, the flow proceeds to step #117.

The fact that the door 11 has been opened means that a user has an intention to do cooking. Therefore, in step #117, the air supply/discharge fan 31 and the ion generator 44 are turned off. Then the flow proceeds to step #118.

In step #118, it is checked whether a predetermined time has passed or not, or, whether a key other than the kitchen sterilization key 16b1 has been operated. If the answer is “YES,” the discharge of positive and negative ions to the space outside the cooking device 1 is finished.

If the door 11 has not been opened in step #113, the flow proceeds to step #114. In step #114, it is checked whether the cancel key 16b2 has been pressed on or not. If the cancel key 16b2 has been pressed on, the flow proceeds to step #116, but if not, the flow proceeds to step #115.

In step #115, it is checked whether a predetermined time set as a positive and negative ions discharging time has passed or not. If the predetermined time has passed, the flow proceeds to step #116.

In step #116, the air supply/discharge fan 31 and the ion generator 44 are turned off, and the discharge of positive and negative ions to the space outside the cooking device 1 is finished.

It is also possible to introduce positive and negative ions into the heating chamber 20 when cooking is not performed. This can be achieved by keeping the air supply damper 38 and the air discharge damper 39 each in the open state and turning on the ion generator 44 and the air supply/discharge fan 31. By selecting this mode, it is possible to sterilize and deodorize the heating chamber 20 when cooking is not performed. It is also possible to sterilize and deodorize the food F or other articles placed in the heating chamber 20 without any application of heat at all.

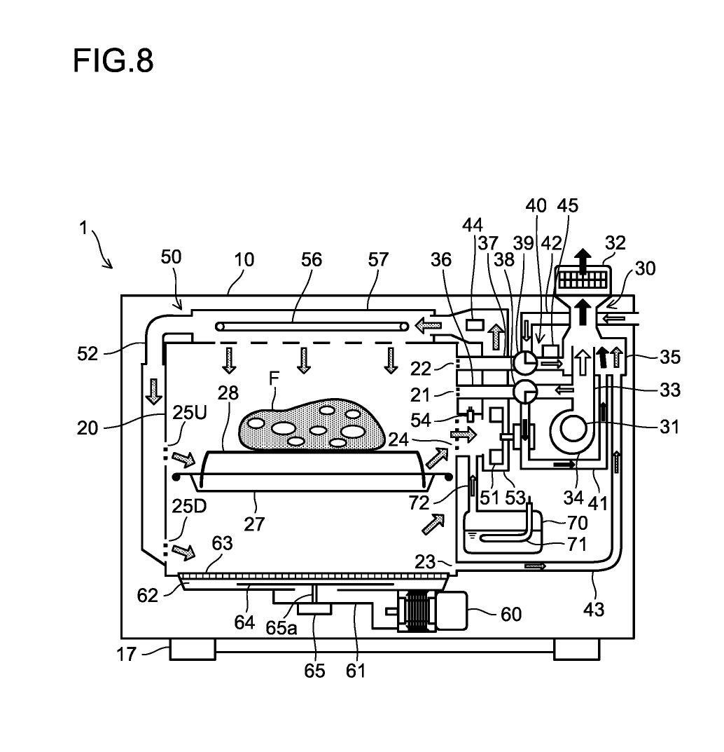

In the first embodiment shown in FIG. 1 to FIG. 6, the ion generator 44 is disposed outside the circulation passage 50. By being thus disposed, the ion generator 44 is protected against heat from the airflow flowing in the circulation passage 50, or greasy fumes or moisture included in the airflow. However, with provision of sufficient safeguards against heat, greasy fumes, and moisture, it is possible to dispose the ion generator 44 in the circulation passage 50. An example having such a configuration is shown in FIG. 8 as a second embodiment.

In the second embodiment, the ion generator 44 is placed at a slightly upstream side of the gas heating heater chamber 57 inside the circulation duct 52. It is possible to introduce positive and negative ions into the heating chamber 20 when the circulation fan 51 is in operation, that is, during any of the superheated-steam cooking, the steam cooking with saturated steam, and hot air cooking,

As in the superheated-steam cooking, the steam cooking with saturated steam, and hot air cooking, if the air supply damper 38 and the air discharge damper 39 are each kept in the closed state and the ion generator 44 inside the circulation duct 52 is driven in the mode where the circulation fan 51 is driven, positive and negative ions are supplied exclusively into the heating chamber 20. As a result, highly concentrated positive and negative ions can be introduced into the heating chamber 20.

When the superheated-steam cooking or the steaming cooking with saturated steam is performed, moisture stays inside the heating chamber 20, and in addition, ambient humidity around the cooking device 1 rises. Even in such a situation, if positive and negative ions are discharged and generate radicals, it is possible to reduce growth of mold inside and outside the heating chamber 20.

In the microwave cooking as well, by turning on the ion generator 44 and the circulation fan 51, it is possible to introduce positive and negative ions into the heating chamber 20. Part of positive and negative ions introduced into the heating chamber 20 is sucked out of the heating chamber 20 into the ejector portion 35, and joins the main stream of the airflow flowing through the ventilation duct 33 to be discharged to the outside of the housing 10 through the outlet port 32. By the thus discharged positive and negative ions, the space outside the cooking device 1 is also sterilized and deodorized.

In the second embodiment, even when cooking is not performed, the air supply damper 38 and the air discharge damper 39 can be brought into the open state, and the ion generator 44, the circulation fan 51, and the air supply/discharge fan 31 can be turned on, by pressing on the kitchen sterilization key 16b1. That is, regardless of whether cooking is performed or not, it is possible to discharge positive and negative ions to the space outside the cooking device 1 at any desired timing to thereby sterilize and deodorize the space.

In the second embodiment as well, it is possible to introduce positive and negative ions into the heating chamber 20 when cooking is not performed. This can be achieved, for example, by keeping the air supply damper 38 and the air discharge damper 39 each in the closed state and turning on the ion generator 44 and the circulation fan 51. By selecting this mode, it is possible to sterilize and deodorize the heating chamber 20 when cooking is not performed. It is also possible to sterilize and deodorize the food F or other articles placed in the heating chamber 20 without any application of heat at all.

It should be understood that the embodiments specifically described above are not meant to limit the present invention, and that many variations and modifications can be made within the spirit of the present invention.

### INDUSTRIAL APPLICABILITY

The present invention is widely applicable to cooking devices.

### LIST OF REFERENCE SYMBOLS

1 cooking device
10 housing
11 door
20 heating chamber
30 air supply/discharge passage
31 air supply/discharge fan
32 outlet port
33 ventilation duct
35 ejector portion
36 air supply pipe (air inflow path)
37 air discharge pipe
38 air supply damper
39 air discharge damper
40 flow path switching device
44 ion generator
50 circulation passage (air inflow path)
51 circulation fan
52 circulation duct
56 gas heating heater
60 magnetron
70 steam generator

1. A cooking device, comprising:
a heating chamber;
an air inflow path through which air is made to flow into the heating chamber; and an ion generator which emits positive and negative ions into air that flows through the air inflow path.

2. The cooking device of claim 1, further comprising
a flow path switching device which outwardly discharges air that flows through the air inflow path and includes positive and negative ions.

3. The cooking device of claim 2,
wherein
an airflow in the air inflow path is generated by a fan; and
the fan and the ion generator are able to be driven regardless of whether cooking is performed or not.

4. The cooking device of claim 1,
wherein
a circulation duct which circulates air in the heating chamber is provided outside the heating chamber, the circulation duct functioning as part of the air inflow path.

5. The cooking device of claim 4,
wherein
the ion generator is disposed outside the circulation duct.

6. The cooking device of claim 4,
wherein
the ion generator is disposed inside the circulation duct.

7. The cooking device of claim 1, further comprising
a heater which heats gas that flows into the heating chamber.

8. The cooking device of claim 1, further comprising
a steam generator which supplies steam into the heating chamber.

9. The cooking device of claim 1, further comprising
a microwave generator which supplies a microwave into the heating chamber.
